(19) United States
(12) Patent Application Publication
(10) Pub. No.: US 2024/0409465 A1
(43) Pub. Date: Dec. 12, 2024

(54) Method for the Preparation of a Carbonated Mineral Component, Carbonated Mineral Component, and Method for the Preparation of a Binder Composition

(71) Applicant: Holcim Technology Ltd, Zug (CH)

(72) Inventors: Philippe Benard, Zug (CH); Vincent Briaud, Zug (CH); Stefan Dietz, Zug (CH); Edelio Bermejo, Zug (CH)

(73) Assignee: Holcim Technology Ltd., Zug (CH)

(21) Appl. No.: 18/717,348

(22) PCT Filed: Dec. 15, 2022
(86) PCT No.: PCT/EP2022/086092

§ 371 Date: Jun. 6, 2024

(30) Foreign Application Priority Data
Dec. 17, 2021 (EP) 21215647.5

(51) Int. Cl. C04B 28/10; C04B 20/02; C04B 28/04; C04B 111/00

(52) U.S. Cl. CPC C04B 28/105; C04B 20/023; C04B 28/04; C04B 2111/00215

(57) ABSTRACT

A method for preparing a carbonated mineral for use in cement is provided; wherein a mineral component with a (CaO+MgO)/SiO₂ weight ratio of 1.2 to 5.0 is
ground to a powder;
mixed with water to form a paste;
the paste is placed in a reactor in an atmosphere containing CO₂;
the paste is carbonated in the reactor; and
the resulting material is dried to constant weight; or
the mineral component is ground to a Blaine fineness between 3′000 cm2/g and 10′000 cm2/g to obtain a powder;
during grinding a CO2 rich gas is injected so that the component carbonates;
the powder is mixed with water at a weight ratio between 0.3 and 1.5 to obtain a paste, or
pre-humidified by adding water at a weight ratio between 0.03 and 0.2;
the resulting material is dried to constant weight at 60-85° C.; and
the resulting material is deagglomerated and sieved.

### RELATED APPLICATIONS

This patent application is a 35 U.S.C. § 371 National Stage entry of PCT/EP2022/086092, filed Dec. 15, 2022, which in turn claims priority based on European Patent Application EP 21215647.5, filed Dec. 17, 2021, the disclosures of which are incorporated herein by reference.

### FIELD OF THE INVENTION

The invention relates to a method for the preparation of a carbonated mineral component, the carbonated mineral component as well as a method for the preparation of a hydraulic binder composition.

### BACKGROUND OF THE INVENTION

The carbonation of materials for use in construction materials is well known. Examples, such as carbonation of steel slag, special cements and concrete demolition waste have already been disclosed. The known carbonation of materials can be divided into two main approaches.

In the first approach the material is hardened by carbonation. Carbonation methods are known for the hardening which use standard processes, wherein this approach is for example disclosed in patent applications filed by Carbstone Innovation, Solidia Technologies or CarbonCure.

The processes disclosed in these applications should have the advantage of sequestering CO₂ by forming particles of calcium carbonate. This can be achieved in several construction applications such as a production of small construction elements like pavers or blocks. In these methods the material to be carbonated may be mixed with small amounts of water and placed into moulds. These moulds are then placed in a curing chamber with a relatively high amount of CO₂, under control temperature and relative humidity. Through the carbonation of the materials, the carbonated elements develop mechanical strength.

The second approach is to carbonate a mineral constituent and to use it afterwards in powder form as a carbonated mineral component. The aim is to reduce the amount of Portland clinker in cement compositions by replacing parts of the Portland cement with that powder made from the carbonated mineral component. In a method according to the second approach the carbonated mineral materials are used in a particular form which is then added to the Portland cements as a cement substituent. For example, demolition waste is carbonated via different processes and the resulting products are used as the cement substituent components. Hereby, the amount of Portland clinker in the cement is lowered for the purpose of providing a material that reduces the CO₂ footprint. In the second approach the carbonation results in the formation of calcium carbonate particles which act as already mentioned as a filler material but do not contribute to the strength development of the cement. Consequently, higher carbonation rates or amounts of carbonated material in the cement result in a lower strength development of the concrete in the application. In practice the amount of carbonated mineral component according to the second approach is limited in cement compositions. The second approach is for example disclosed in EP 3656750, WO2019/115722, EP 3581257 and EP 3498681 A1.

From Yingpeng Hu, Journal of Energy Chemistry, volume 26, issue 5, September 2017, pages 927-935 the indirect mineral carbonation of a blast-furnace slag with (NH₄)₂SO₄ as a recyclable extant is known, wherein in this document (NH₄)₂SO₄ was used to extract calcium and magnesium from blast-furnace slag (the main phases of gehlenite and akermanite by using low-temperature roasting to fix CO₂ through aqueous carbonation.

Daniela Angulo, Materiales de Construccion 69 (333): 182, relates to the carbonation of hybrid concrete with high blast-furnace slag content and its impact on structural steel corrosion.

The effect of blast-furnace slag replacement the ratio and curing method on pore structure and the change after carbonation on cement paste is disclosed in Junho Kim, Seung Hyun Na and Yukio Hama, materials (Basel), Nov. 13, 2020 (21): 4787.

### SUMMARY OF THE INVENTION

The object of the invention is to provide for a method for the manufacturing of a carbonated mineral component which does not lead to a loss of strength in case it is added to a hydraulic binder composition as a substituent for a hydraulic component in particular a cement.

The object is met by way of the method described and claimed herein.

It is a further object of the present invention to provide for a carbonated mineral component as a substituent for a hydraulic component in a hydraulic binder composition.

This object is met by way of the mineral component described and claimed herein.

It is still a further object of the invention to provide a method for the manufacturing of a hydraulic binder composition with a carbonated mineral component.

This object is met by way of the method for the manufacturing of the mineral binder described and claimed herein.

Further embodiments are described and claimed herein.

It was surprisingly found that the use of a carbonated mineral component according to the invention does not lead to a loss of the 28-day strength in a cement concrete which is prepared with a hydraulic binder component and the carbonated mineral component of the present invention. The mineral component according to the invention has a weight ratio of (CaO+MgO)/SiO₂ between 1.20 and 5.0, in particular between 1.20 and 2.0. Suitable mineral components which meet this ratio are for example ground granulated blast-furnace slag or class C fly ashes according to the definition provided in the standard ASTMC618. It was found that a ratio below 1.20 is not suitable.

The CaO content in the mineral component should at least be 35 wt.-% measured by XRF.

In a first embodiment, the method according to the invention may comprise the following steps:
1. The mineral component is ground to a Blaine fineness comprised between 3′000 cm²/g and 10′000 cm²/g in particular between 5′000 cm²/g and 8′000 cm²/g to obtain a powder;
2. The powder is mixed with water at a solid to water weight ratio comprised between 0.3 and 1.5 to obtain a paste, or pre-humidified by adding water at a solid to water weight ratio comprised between 0.03 and 0.2;
3. The paste or the pre-humidified powder composed of the mineral component with water is placed in a reactor which operates at normal atmospheric pressure, a temperature of 50-90° C. and relative humidity of 56-95% in an atmosphere containing CO₂;
4. The paste is left to carbonate in the reactor for a duration between 0.5 and 52 hours, preferentially 12 to 30 hours, more preferred 24 hours;
5. The hardened resulting material is dried at a temperature of 60-85° C., preferentially 80° C. until its weight is constant;
6. The resulting material is deagglomerated and sieved;
7. A mineral component is used with at least one, some or all of the properties of the following group:
   the (CaO+MgO)/SiO₂ weight ratio is 1.20 to 5.0, preferably 1.26 to 5.0
   the amorphous content is above 66%, preferably above 75%, in particular over 85%.

In particular it was found out by the inventors that the higher the (CaO+MgO)/SiO₂ weight ratio is the lower the amorphous content can be.

The reactor is preferentially fed with a CO₂ rich gas from a cement plant, which contains at least 5% CO₂. This gas contains further contains water vapour that provides the required environment for the carbonation to take place. This gas may be cooled down so as to reach a temperature of 60-85° C. in the reactor.

In particular, the resulting material is sieved to 63 μm to exclude coarse aggregates.

The resulting material can be further ground to a higher fineness. The ground resulting material is blended into a hydraulic mineral component, in particular into a cementitious component and in particular to a Portland cement.

In an alternative embodiment, the method according to the invention may comprise the following steps:
1. the mineral component is ground to a Blaine fineness comprised between 3′000 cm²/g and 10′000 cm²/g to obtain a powder;
2. during grinding in a mill a CO₂ rich gas is injected into the mill so that the component carbonates.

3. the powder is mixed with water at a solid to water weight ratio comprised between 0.3 and 1.5 to obtain a paste, or pre-humidified by adding water at a solid to water weight ratio comprised between 0.03 and 0.2;

4. the hardened resulting material is dried at a temperature of 60-85° C., preferentially 80° C. until its weight is constant;

5. the resulting material is deagglomerated and sieved;

6. A mineral component is used with at least one, some or all of the properties of the following group:
the (CaO+MgO)/SiO₂ weight ratio is 1.20 to 5.0, preferably 1.26 to 5.0
the amorphous content is above 66%, preferably above 75%, in particular over 85%.

The mill is preferentially fed with a CO₂ rich gas, in particular combustion gas from a cement plant, which contains at least 5% CO₂. This gas contains further contains water vapour that provides the required environment for the carbonation to take place. This gas may be cooled down so as to reach a temperature of 60-85° C. in the mill.

The blending into that cementitious component can be achieved by mixing in the finally ground resulting material into the cementitious component or adding it before grinding the cement clinker to the clinker.

The carbonation process can be carried out according to any known industrial process using a CO₂ containing gas. In particular, according to the invention the gas may contain a minimum of 5% of CO₂.

As a result, it was found that up to 15% CO₂ can be captured by the mineral component to be carbonated. In particular, this may happen when the whole component is mixed with water at a water cement ratio between 0-1 or somewhat more and exposed to the CO₂ atmosphere for example 24 hours.

It was further found that a carbonation duration of 30 minutes can result in up to 5% CO₂ captured by the mineral component.

Further, it could be derived that the level of CO₂ capture is variable according to the slag source and depends in particular on the amount of amorphous phases in the slag, the fineness of the slag and the CaO+MgO+Na₂O equivalent.

Surprisingly it was found that a hydraulic binder composition with the carbonated mineral component pertaining to the compressive strength performs similar to a hydraulic binder composition with a non-carbonated mineral reference material. In particular, this is valid for a replacement of a cementitious component by the carbonated mineral component or the non-carbonated mineral component of 25 weight-% at least, respectively.

Further it was found that it is advantageous to us a mineral component with a high amorphous content instead of a mineral component mainly consisting of crystalline content. There are several aspects in this regard. Firstly a mineral component with a high amorphous content has a better solubility and grindability so that it is quite reactive with regard to the mixing of a paste in an binder composition with water. Further—as not the whole amount of the mineral component might carbonate—the non-carbonated part-due to its pozzolanic properties-contributes significantly to the strength of the mortar or concrete. From a security aspect this guarantees always a sufficient strength development.

Further it was found that the carbonation step is essential. In case a slag is carbonated the carbonation mainly occurs with the CaO of the slag. A slag which was carbonated to a weight gain of 10% did not lower the 28 day strength. A slag in which the 10% carbonation weight gain was simulated by adding limestone to the same non-carbonated slag lowered the 28 day compressive strength so that it can be concluded that the carbonation step indeed has an influence.

In summary it was surprisingly found that a selected carbonated mineral component with a special composition and a selected weight ratio between CaO+MgO and SiO₂ leads to a substituent for a cementitious constituent in a hydraulic binder composition without the otherwise expected loss of strength and in particular compressive strength after 28 days.

The invention in particular relates to a method for the preparation of a carbonated mineral component in particular for the use as a substituent of cement in hydraulic binder compositions wherein a mineral component

with at least one, some or all of the properties of the following group:
the (CaO+MgO)/SiO₂ weight ratio is 1.20 to 5.0, preferably 1.26 to 5.0
the amorphous content is above 66%, preferably above 75%, in particular over 85%-ground to obtain a powder;
the powder is mixed with water to obtain a paste;
the paste composed of the mineral component with water is placed in a reactor in an atmosphere containing CO₂;
the paste is left to carbonate in the reactor for a predetermined time
the hardened resulting material is dried until its weight is constant;
the resulting material is deagglomerated and sieved or
the mineral component is ground to a Blaine fineness comprised between 3′000 cm²/g and 10′000 cm²/g to obtain a powder;
during grinding in a mill a CO₂ rich gas is injected into the mill so that the component carbonates.
the powder is mixed with water at a solid to water weight ratio comprised between 0.3 and 1.5 to obtain a paste, or pre-humidified by adding water at a solid to water weight ratio comprised between 0.03 and 0.2;
the hardened resulting material is dried at a temperature of 60-85° C., preferentially 80° C. until its weight is constant;
the resulting material is deagglomerated and sieved.

In an embodiment the minimum content of CaO in the mineral component is 35 wt-% measured by XRF.

In an embodiment the CO₂ rich gas is a combustion gas from a cement plant.

In an embodiment the (CaO+MgO)/SiO₂ weight ratio is 1.26 to 5.0.

In an embodiment the mineral component is ground to a Blaine fineness of at least 3000 cm 2/g.

In an embodiment the powder of the mineral component is mixed with water at a solid to water weight ratio comprised between 0.3 and 1.5.

In an alternative embodiment the powder of the mineral component is mixed with water at a solid to water weight ratio comprised between 0.03 and 0.2. In this embodiment, water can for example be sprayed onto the mineral component before carbonation.

In an embodiment the reactor operates at normal atmospheric pressure, a temperature of 50-90° C. and relative humidity of 56-95%.

In an embodiment the paste is left to carbonate in the reactor for a duration between 12 and 52 hours, preferentially 18 to 30 hours, more preferred 20 to 26 hours and most preferred 24 hours.

In an embodiment the hardened resulting material is dried at a temperature of 60-85° C., preferentially 80° C.

In an embodiment the resulting material is sieved to 63 μm to exclude coarse aggregates.

In an embodiment the resulting carbonated mineral component is ground to a Blaine fineness of 3′000 cm²/g to 10′000 cm²/g preferentially between 5000 and 8000 cm²/g.

In an embodiment the mineral component is chosen from at least one of ground granulated blast-furnace slag, ground steel slag, fly ash, ground concrete demolition waste, and preferably ground granulated blast-furnace slag only.

Another aspect of the invention relates to a carbonated mineral component in particular a carbonated mineral component manufactured as described before with a (CaO+MgO)/SiO₂ weight ratio of 1.2 to 5.0 calculated on the non-carbonated constituents.

In an embodiment the carbonated mineral component has a degree of carbonization between 5 and weight-% calculated on the non-carbonated constituents, preferably between 8 and 16 weight-% calculated on the non-carbonated constituents.

In an embodiment the carbonated mineral component has a Blaine fineness of 3′000 cm²/g to 10′000 cm²/g

Still another aspect of the invention pertains to a method for the preparation of a binder composition in particular a hydraulic binder composition wherein a carbonated mineral component as described before with a (CaO+MgO)/SiO₂ weight ratio of 1.2 to 5.0 calculated on the weight of the non-carbonated constituents is mixed with at least a cementitious component in particular a Portland cement or a Portland cement clinker.

In an embodiment the carbonated mineral component is added to cement clinker before or at the milling and ground together with the cement clinker to obtain a binder composition comprising at least the carbonated mineral component and the cement.

In an embodiment the ground carbonated mineral component with a Blaine fineness of 3′000 cm²/g to 10′000 cm²/g in particular of 5′000 cm²/g to 8′000 cm²/g is mixed at least with the ground cement to obtain a binder composition comprising at least the carbonated mineral component and the cement.

Still another aspect of the invention relates to the use of a carbonated mineral component as described before, manufactured with a method as described before as a substituent for cement in a hydraulic binder composition.

### BRIEF DESCRIPTION OF THE FIGURES

The invention is further explained by way examples. The examples are shown in accompanying drawings, which show:

FIG. 1: a table showing the list of materials used;

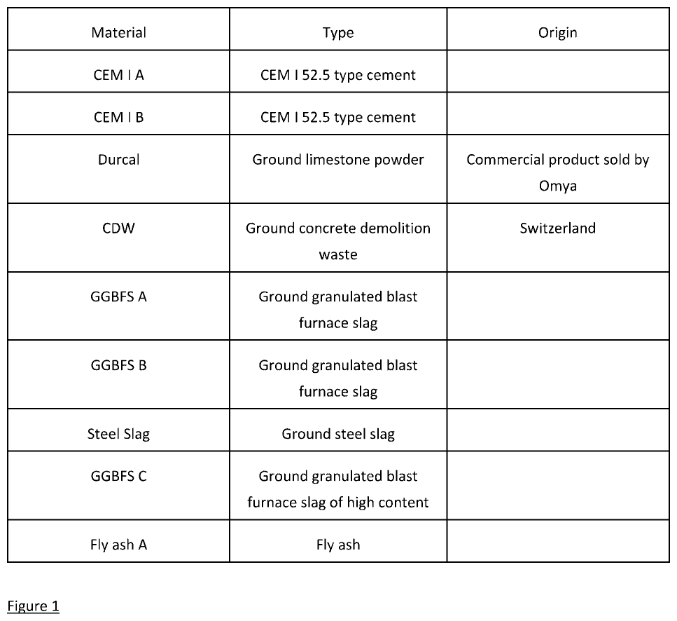

FIG. 2: the fineness and the Blaine surface of the used materials;

FIG. 3: the relevant chemical composition of the components;

FIG. 4: the compressive strength of the materials and material admixtures without carbonation;

FIG. 5 the compressive strength of the materials and material admixtures with carbonation

FIG. 6: schematically the test device;

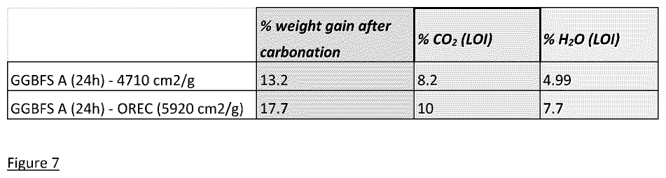

FIG. 7: the impact of the fineness of the mineral component;

FIG. 8: three comparative examples in which carbonated material is substituted by limestone.

### DETAILED DESCRIPTION OF THE INVENTION

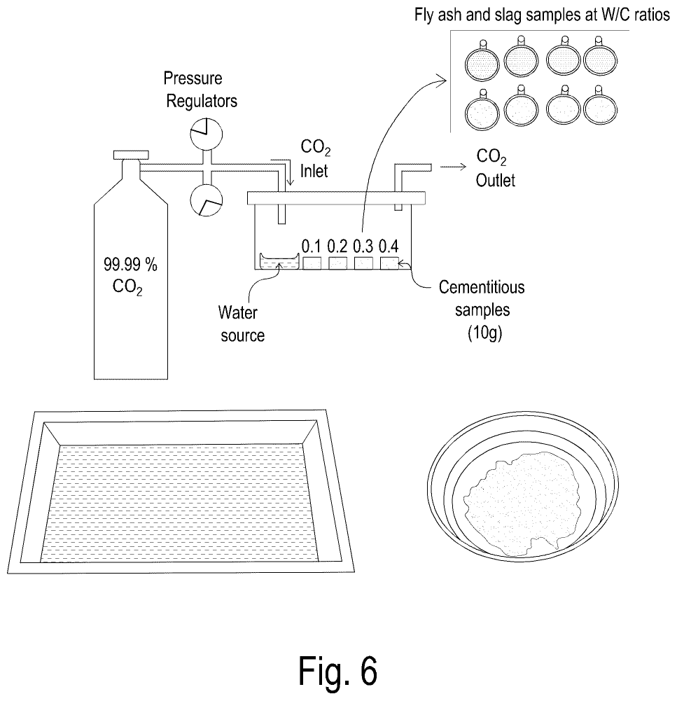

With reference to FIG. 5 samples of 10 g each are prepared from a mineral component and mixed with water with different water-cement ratios in sample pans.

The sample pans with the sample materials are introduced in a market available container which allows temperature control as well as a gas control. The gas control comprises the composition of the gas and the gas pressure wherein the container has respective gas connections (inlet/outlet) to provide for a gas flow.

The relative humidity is controlled by means of a tank of deionised water laid on the bottom of the container.

The temperature is set to 70-80° C. and the CO₂-pressure at the inlet of the chamber is set to 1.02 bar and remain constant. The relative humidity which was set by means of the tank was measured as to be 80-85% in the reactor.

After a predetermined time in the container the carbonation and hydration amount of the respective materials were determined.

a) Total Mass Gain with Respect to Mineral Component

The total mass gain (Δm, see eq. (1)) is related to both bound water (Δm_H2O) and bound CO₂ (Δm_CO₂) with respect to the mineral component [g/g of mineral component].

After carbonation, the samples are dried at 80° C. to get the final dry mass noted m(f,dry), expressed in grams [g].

The mass of the samples after mixing and before carbonation is known, it is noted m(0,wet) and expressed in grams [g].

The mass of the solid, i.e. the dry mass, is calculated from initial mix composition, it is noted m(0,dry) and expressed in grams [g].

$$Δ m = ( m ( f , dry ) - m ( 0 , dry ) ) / m ( 0 , dry \qquad Equation 1$$

b) CO₂ Mass Gain with Respect to the Mineral Component:

The bound water content and bound CO₂ content with respect to the mass of samples is also calculated from the measured mass of samples, respectively at 550° C. and 950° C. The mass difference of samples between 80° C. and 550° C. is related to bound water content (see eq. (2)) whereas the mass loss of samples between 550° C. and 950° C. is related to CO₂ content (see eq. (3)).

$$Δ m \_H2O = ( ( m ( f , 80 ) - m ( f , 550 ) ) ) / m ( 950 ) \qquad Equation 2$$

$$Δ m \_CO2 = ( ( m ( f , 550 ) - m ( f , 950 ) ) ) / m ( 950 ) \qquad Equation 3$$

In this way prepared carbonated mineral components were used to prepare respective mortars and measuring the compressive strength according to the norm NF EN196-1 of September 2016.

In the tables according to the Figures the samples are shown, wherein all samples, which are marked 75/25 were made of a composition of a cement CEM I (A or B) and 25 wt.-% of the respective mineral component. Carbonated mineral components according to the invention were used as well as the same mineral components without the carbonation step to elaborate the differences in the strength development. The respective 75/25 admixtures were used to prepare a mortar and the compressive strength was determined as described above.

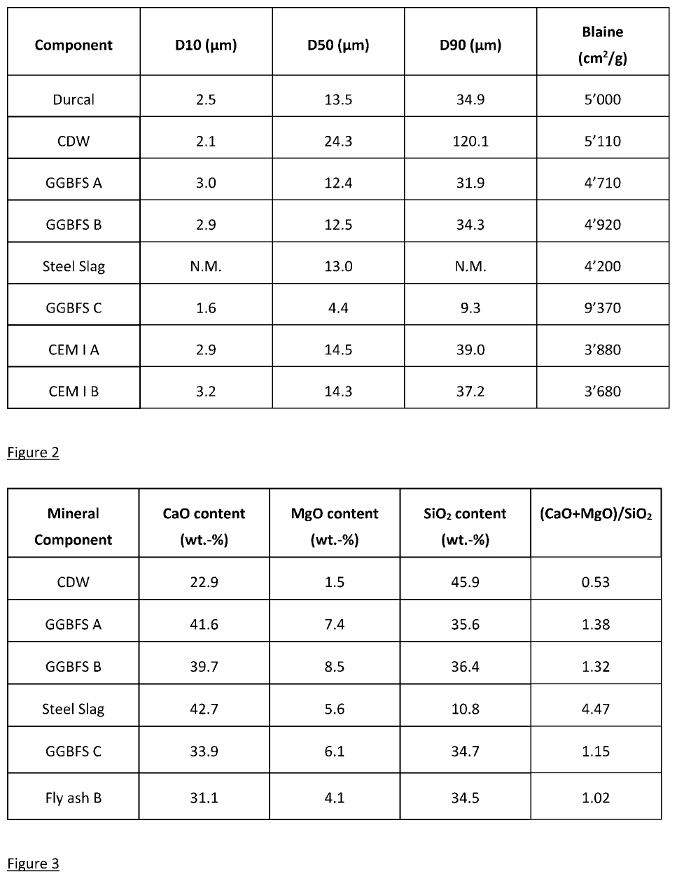

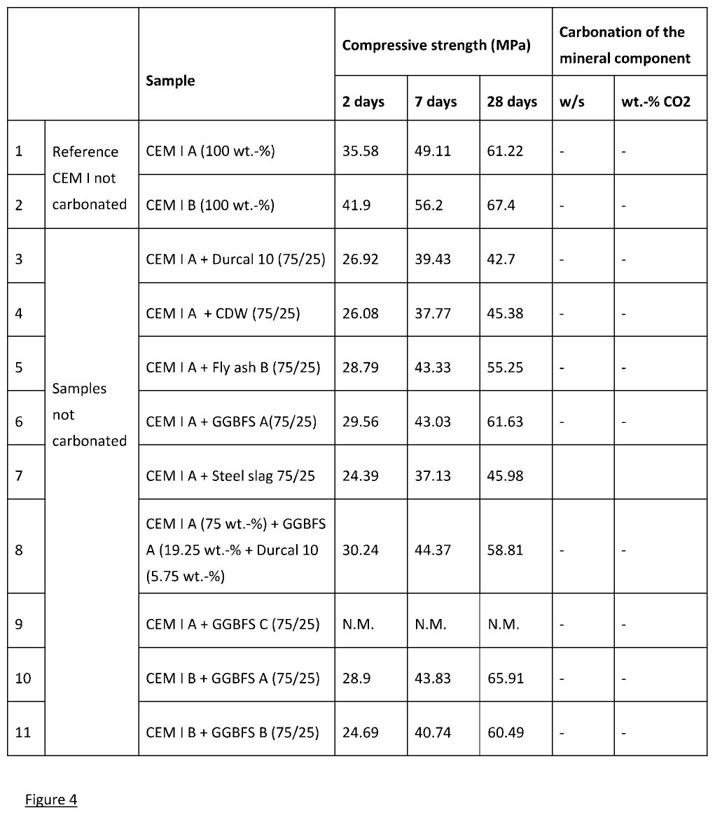

FIG. 2 and FIG. 3 lists the mineral components used in the examples. As will be confirmed in the results discussed further below, GGBFS C and the fly ash B are not suitable for the present invention.

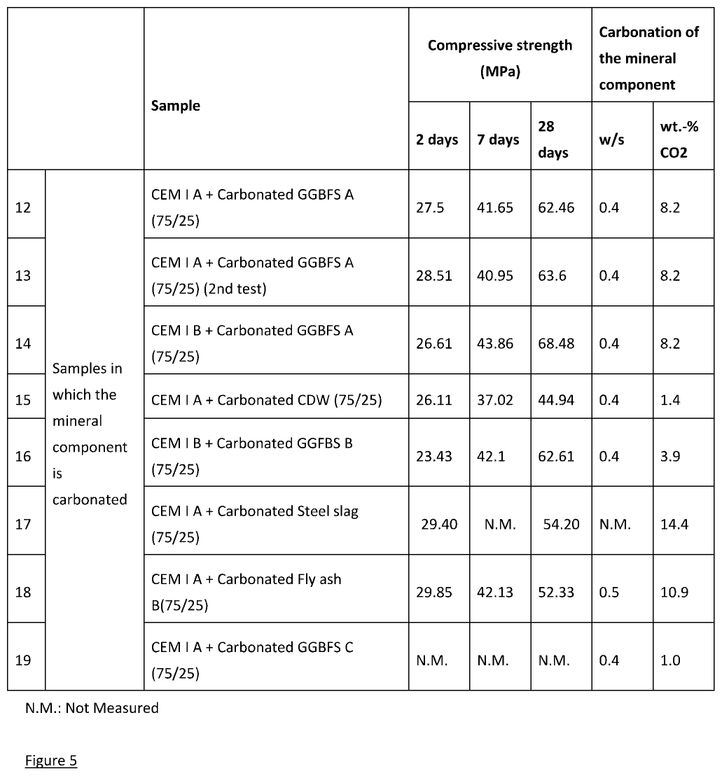

The results related to the strength of the mortar and carbonation of the mineral component are presented in FIG. 4.

As a comparative example, sample 1 and sample 2 pertain to a pure CEM I (A and B) sample without an additional mineral component.

Samples 3-11 (FIG. 4) show the impact of the substitution of CEM I A and B with a non-carbonated mineral component on strength development. In all cases in comparison to a mortar made of the pure CEM I cement, the strength at 2 and 7 days is always reduced and the strength at 28 days is reduced, except in the case of ground blast-furnace slags B which contributes positively to the compressive strength at 28 days at a similar level as CEM I. This could be expected according to the latent hydraulic properties of this blast-furnace slag.

Samples 12-19 (FIG. 5) are examples with carbonated mineral components. The mineral components were carbonated for 24 hours in the already defined way. As it can be seen the samples 12 and 14 with CEM I A and CEM I B and blast-furnace slag A as the mineral component led to a compressive strength after 28 days in the range which can be achieved by the corresponding CEM I alone. A certain deviation occurs between samples 12 and 13, which is not significant.

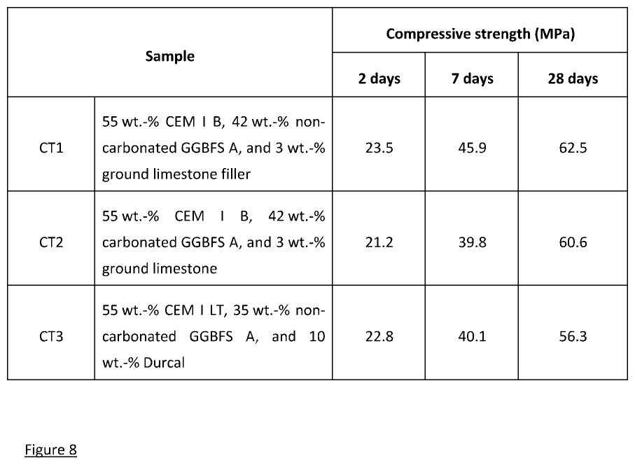

A closer look to the impact of the fineness of the mineral component was made by grinding the blast-furnace slag to two different Blaine grades: 4′710 cm²/g and 5′920 cm². Here too, these constituents were carbonated for 24 hours in the already defined way. The results can be seen in FIG. 7 wherein the weight gain after carbonation is higher with a higher fineness and more or less uniformly the carbonation weight gain is about 2%, wherein the weight gain by the introduction of water is 2.7%.

Sample 5 in FIG. 4 pertains to the use of CEM I A with a fly ash B without any carbonation wherein sample 18 pertains to the same CEM I A and carbonated fly ash. In comparison in particular of sample 18 showing a carbonated fly ash B with CEM I A and the same constituents but with a non-carbonated fly ash which is sample 5, it can be seen that the carbonation caused a 28-day compressive strength of 52.33 MPa and 55.25 MPa in sample 5.

As in sample 18 the carbonated fly ash B obviously does not contribute to a higher compressive strength than in comparison to sample 5 it can be concluded that according to the lower ratio of (CaO+MgO)/SiO₂ of 1.02, this example is not working and therefore, outside of the inventive range. In this sample the dilution effect of the fly ash as a mineral component was not compensated by carbonation.

Another sample showing the lower limit is the ground concrete demolition waste (CDW) with a ratio of (CaO+MgO)/SiO₂ of 0.53. A sample of CEM I A with CDW (sample 4) showed a remarkable drop of the 28 days compressive strength from over 60 to 45.38 MPa. The same situation but with a carbonated CDW (sample 15) did not lead to a higher compressive strength.

Samples 9 and 19 pertain to the use of GGBFS C as a non-carbonated (sample 9) and carbonated (sample 19) mineral component. This mineral component has a (CaO+MgO)/SiO₂ ratio of 1.15. Example 19 shows that this slag GGBFS C did not carbonate efficiently, as the carbonation, expressed in wt.-% CO₂, was only of 1 wt.-%. This example is therefore not working and therefore, outside of the inventive range.

Therefore, a (CaO+MgO)/SiO₂ ratio under 1.20 is not suitable for the invention. A ratio above 1.26 is preferred.

Samples 7 and 17 pertain to the use of steel slag BOF, which has a (CaO+MgO)/SiO₂ ratio of 4.47. When compared to the non-carbonated test (Sample 7), the carbonated sample (Sample 17) shows a particularly strong increase of the compressive strength at 28 days. This sample is therefore working and is within the inventive range.

The invention substitutes a cementitious material in a hydraulic binder composition with a selected group of mineral components with a (CaO+MgO)/SiO₂ ratio between 1.20 and 5.0, in particular 1.20 and 2.0 in an advantageous manner.

It was surprisingly found that carbonating these mineral components and grinding them to a sufficient fineness does not lower the 28 compressive strength in comparison to the binder composition using pure cementitious material without the mineral component. It is thereby possible to lower the carbon footprint of such a hydraulic binder composition and the resulting concrete remarkably but avoiding any detrimental effect on the long term compressive strength.

To further characterize the advantages of the present invention, additional comparative tests have been carried out, in which 3 cement compositions have been tested:
CT1: A CEM III/A cement, comprising 55 wt.-% CEM I LT, 42 wt.-% non-carbonated GGBFS A, and 3 wt.-% ground limestone filler
CT2: A CEM III/A cement, comprising 55 wt.-% CEM I LT, 42 wt.-% carbonated GGBFS A, and 3 wt.-% ground limestone
CT3: A CEM III/A cement, comprising 55 wt.-% CEM I LT, 35 wt.-% non-carbonated GGBFS A, and 10 wt.-% Durcal 10.

The GGBFS A carbonates to capture an equivalent of 8.2 wt.-% CO₂, which corresponds to the formation of an amount of calcium carbonate of 7 wt.-% of the total weight of cement. CT2 then has the following full composition: is 55 wt.-% CEM I B, 35 wt.-% non-carbonated GGBFS A, and 10 wt.-% ground limestone.

CT3 was then prepared by replacing all sources of calcium carbonate in CT2 by Durcal 10. Durcal 10 is a fine ground calcium carbonate provided by Omya, having a Blaine value of 5′000 cm²/g. The total amounts of CEM I B and non-carbonated GGBFS A in samples CT2 and CT3 are therefore the same. Furthermore, as the carbonation results in the formation of calcium carbonate in the mineral component, the total amount of calcium carbonate in samples CT2 and CT3 remains also the same.

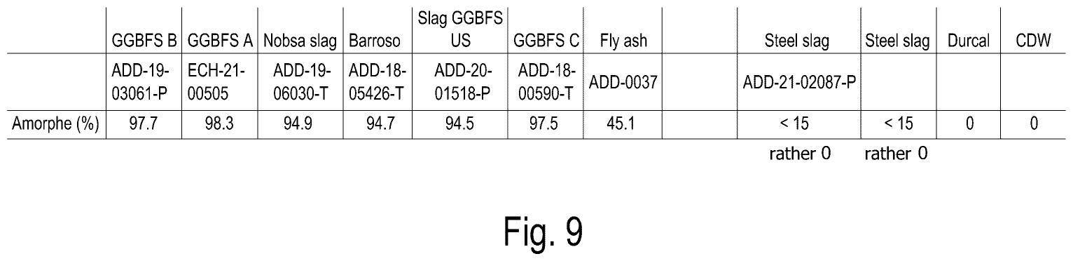

The results of these three tests are provided in FIG. 8. When compared to CT1, CT2 shows a small reduction in strength and 2 days, 7 days, and 28 days. When compared to CT1, CT3 also shows a smaller reduction in strength at 2 days, and stronger decrease at 28 days. Interestingly, even though the total composition of CT2 and CT3 are the same, the compressive strength at 28 days of CT3 is significantly lower to that of CT2.

1-20. (canceled)

21. A method for preparing a carbonated mineral component, comprising the steps of:
providing a mineral component including CaO, MgO and SiO₂ in a weight ratio (CaO+MgO)/SiO₂ of about 1.2 to about 5.0 and having an amorphous content of at least about 66% by weight;
carbonating the mineral component to form a hardened material using a first sequence of steps or, alternatively, a second sequence of steps;
drying the hardened material to a constant weight; and
deagglomerating and sieving the hardened material to form the carbonated mineral component;
wherein the first sequence of steps comprises:
grinding the mineral component to obtain a powder;
mixing the powder with water to form a paste;
placing the paste in a reactor in an atmosphere that includes a CO₂ rich gas; and
carbonating the paste in the reactor to form the hardened material;
and the second sequence of steps comprises:
grinding the mineral component in a mill;
during grinding of the mineral component, injecting the CO₂ rich gas into the mill to carbonate the mineral component, yielding a carbonated powder; and
either a) mixing the carbonated powder with water at a solid to water weight ratio of about 0.3 to about 1.5, or b) pre-humidifying the carbonated powder using a solid to water ratio of about 0.03 to about 0.2, to obtain the hardened material.

22. The method of claim 21, wherein the step of drying the hardened material to the constant weight is preformed at a temperature of about 60° C. to about 85° C.

23. The method of claim 21, wherein the mineral component comprises at least about 35% by weight of the CaO.

24. The method of claim 21, wherein the CO₂ rich gas is a combustion gas from a cement plant.

25. The method of claim 21, wherein the weight ratio of (CaO+MgO)/SiO₂ is 1.26 to 5.0.

26. The method of claim 21, wherein, after grinding the mineral component, the powder or carbonated powder has a Blaine fineness between about 3000 cm²/g and about 10,000 cm²/g,

27. The method of claim 26, wherein the Blaine fineness is between 5000 cm²/g and 8000 cm²/g.

28. The method of claim 21, wherein the powder or carbonated powder is mixed with the water at a solid to water weight ratio between 0.3 and 1.5.

29. The method of claim 21, comprising the first sequence of steps, wherein the reactor is operated at atmospheric pressure, a temperature of 50-90° C., and a relative humidity of 56-95%.

30. The method of claim 21, comprising the first sequence of steps, wherein the paste is carbonated in the reactor for a duration between 12 and 52 hours.

31. The method of claim 30, wherein the duration is between 18 and 30 hours.

32. The method of claim 21, wherein the hardened material is sieved to particle sizes of 63 μm or less to exclude coarse aggregates.

33. The method of claim 21, wherein the mineral component is selected from one or more of ground granulated blast-furnace slag, ground steel slag, fly ash, and ground concrete demolition waste.

34. A carbonated mineral including carbonated and non-carbonated constituents;
the non-carbonated constituents including CaO, MgO and SiO₂ in a weight ratio (CaO+MgO)/SiO₂ of about 1.2 to about 5.0 and having an amorphous content of at least about 66% by weight.

35. The carbonated mineral of claim 34, wherein the carbonated mineral has a degree of carbonation of about 5% to about 20% by weight.

36. The carbonated mineral of claim 35, wherein the degree of carbonation is about 8% to about 16% by weight.

37. The carbonated mineral of claim 34, wherein the carbonated mineral has a Blaine fineness of 3000 cm²/g to 10,000 cm²/g.

38. A method of preparing a binder composition, comprising the steps of:
providing a carbonated mineral component including CaO, MgO and SiO₂ in a weight ratio (CaO+MgO)/SiO₂ of about 1.2 to about 5.0; and
mixing the carbonated mineral component with a cementitious component selected from the group consisting of a Portland cement, a Portland cement clinker, and combinations thereof.

39. The method of claim 38, wherein the carbonated mineral component is added to the cementitious component and ground together with the cementitious component to obtain the binder composition.

40. The method of claim 38, wherein the carbonated mineral component has a Blaine fineness of 3000 cm²/g to 10,000 cm²/g.
